(19) United States
(12) Patent Application Publication
(10) Pub. No.: US 2026/0051205 A1
(43) Pub. Date: Feb. 19, 2026

(54) STEERING COLUMN AND METHOD FOR DETECTING A PINCH SITUATION WHEN ADJUSTING A STEERING COLUMN IN A MOTOR VEHICLE

(71) Applicants: thyssenkrupp Presta AG, Eschen (LI); thyssenkrupp AG, Essen (DE)

(72) Inventors: Gabor MAJOR, Sevelen (CH); Patrick RIEDMANN, Dornbirn (AT)

(73) Assignees: thyssenkrupp Presta AG, Eschen (LI); thyssenkrupp AG, Essen (DE)

(21) Appl. No.: 19/297,379

(22) Filed: Aug. 12, 2025

(30) Foreign Application Priority Data
Aug. 16, 2024 (BE) BE 2024/5532

(51) Int. Cl. G07C 5/08; B62D 1/185

(52) U.S. Cl. CPC G07C 5/0808; B62D 1/185

(57) ABSTRACT

A method for detecting a pinch situation during the electromechanical adjustment of a steering column in a motor vehicle by means of at least one electric motor, comprises, during an adjustment operation, for the at least one electric motor sensing a current signal and evaluating a gradient of the current signal, wherein, during the evaluation of the gradient of the current signal, a check is made as to whether the gradient of the current signal lies within predefined limits, wherein a pinch situation is detected when the gradient of the current signal lies within the predefined limits. An adjustable steering column for a motor vehicle comprises a supporting unit by which an actuator is adjustably held, and an adjustment device which is designed to adjust the actuator relative to the supporting unit, wherein the adjustment device, to adjust the actuator, comprises at least one electric motor and a control unit is assigned to the steering column. The steering column is designed to carry out a method as above.

### CROSS REFERENCE TO RELATED APPLICATION

This application is a U.S. Non-Provisional that claims priority to Belgian Patent Application No. BE 2024/5532, filed Aug. 16, 2024, the entire content of which is incorporated herein by reference.

### FIELD

The present disclosure relates to a method for detecting a pinch situation during the electromechanical adjustment of a steering column in a motor vehicle.

### BACKGROUND

Furthermore, the invention relates to an adjustable steering column for a motor vehicle, comprising a supporting unit by which an actuator is adjustably held, and an adjustment device which is designed to adjust the actuator relative to the supporting unit, wherein the adjustment device, to adjust the actuator, comprises at least one electric motor and a control unit is assigned to the steering column.

In the prior art, US 2018/0079441 A1 discloses a steering column which is adjustable between a stowed position and an operating position. Furthermore, DE 10 2019 108 466 A1 discloses an adjustable steering column having an actuator and a supporting unit for a motor vehicle, wherein the steering column can be moved into a stowed position. By means of a position detection device, the position of an actuator relative to the supporting unit is determined, wherein the actuator is adjusted with the determined position being taken into consideration.

Furthermore, for a steering wheel arrangement having an electrically adjustable steering wheel, EP 3 042 825 A1 discloses detecting contact or resistance when retracting the steering wheel and returning the steering wheel into an operating position in the event of such detection. Moreover, DE 10 2022 125 280 A1 discloses a method for pinch detection of a steering column of a vehicle, wherein, for an electric motor of the steering column, a current slew rate and a speed slew rate are sensed and evaluated via a threshold comparison.

Thus a need exists to better detect a pinch situation during the adjustment of an adjustable steering column in a motor vehicle, and in particular of reducing the number of erroneously detected pinch situations.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows, in a perspective illustration, a first view of an exemplary embodiment of a steering column according to the invention.

FIG. 2 shows, in a perspective illustration, a second view of the exemplary embodiment according to FIG. 1.

FIG. 3 shows, in the form of a graph, a sensed current signal over time with indicated limits in a defined adjustment range.

FIG. 4 shows, in a simplified side view, a structure of an exemplary embodiment for determining the limits.

FIG. 5 shows a flow chart for an exemplary embodiment of a method according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a a method for detecting a pinch situation during the electromechanical adjustment of a steering column in a motor vehicle by means of at least one electric motor, wherein, during an adjustment operation, for the at least one electric motor a current signal is sensed and a gradient of the current signal is evaluated.

The proposed solution provides a method for detecting a pinch situation during the electromechanical adjustment of a steering column in a motor vehicle by means of at least one electric motor, in particular during the adjustment of a steering column between a stowed position and an operating position, wherein, during an adjustment operation, for the at least one electric motor a current signal is sensed and a gradient of the current signal is evaluated. During the evaluation of the gradient of the current signal, a check is made as to whether the gradient of the current signal lies within predefined limits, wherein a pinch situation is detected when the gradient of the current signal lies within the predefined limits. Advantageously, a check is, in particular, made as to whether the gradient of the sensed current signal has exceeded a lower limit, but the gradient of the sensed current signal is below an upper limit. It has been found that, as a result of the check as to whether the gradient of the current signal lies within the predetermined limits, erroneous detection of pinch situations can be prevented, since current fluctuations, which are attributable in particular to mechanical influences during adjustment of the steering column, can be ruled out better as possible triggers for detection of a pinch situation. Thus, for example, the adjustment of the steering column as far as a limiter in the form of a hard stop can result in a steep gradient of the current signal, wherein the upper limit of the predefined limits is then advantageously defined such that, in that case, the detected gradient exceeds the upper limit and thus a pinch situation is not detected. A pinch situation exists in particular when the steering column is adjusted against a resistance caused by an obstacle, i.e. in particular when contact with a body part of a driver occurs during the adjustment.

According to one advantageous refinement of the method, the limits are predefined by a first gradient line, which forms an upper limit, and a second gradient line, which forms a lower limit. A pinch situation is advantageously detected when the gradient of the sensed current signal lies between the first gradient line and the second gradient line. If the first gradient line is exceeded or at least persistently exceeded, a pinch situation is thus in particular not detected. In a corresponding manner, a pinch situation is in particular not detected when the gradient of the sensed current signal lies below the second gradient line. As a result of a gradient line as upper and lower limit, the number of incorrectly detected pinch situations can advantageously be reduced further.

Advantageously, the first gradient line is a portion of a first gradient curve, in particular of a first gradient straight line, and the second gradient line is a portion of a second gradient curve, in particular of a second gradient straight line. Advantageously, a gradient line can be defined comparatively easily in this way. Furthermore, the gradient line can be adapted better such that pinch situations and non-pinch situations can be distinguished better from one another. In particular, the gradient of the first gradient line is greater than the gradient of the second gradient line.

According to a further advantageous aspect of the invention, the limits are determined in advance. Advantageously, in the process, in particular as a result of corresponding actuation of the at least one electric motor, the steering column in each case strikes an obstacle in a plurality of adjustment operations during adjustment. The obstacle in this case simulates in particular a possible actual obstacle, in particular a human body part. A current signal, resulting when the respective obstacle is struck, of the at least one electric motor is then advantageously sensed and evaluated with regard to its gradient. The limits for the detection of a pinch situation are then advantageously predefined such that the gradients of the current signals sensed in the motor vehicle during the adjustment lie within the limits. Advantageously, the limits can thus be defined with high precision. Pinch situations can thus be detected very reliably. Errors, in particular as a result of a pinch situation being detected even though there is no pinch situation, can be avoided even better.

In addition, a method for setting the limits for a method according to the invention for detecting a pinch situation during the electromechanical adjustment of a steering column in a motor vehicle by means of at least one electric motor is advantageously provided, wherein, in a plurality of adjustment operations, the steering column in each case strikes an obstacle during adjustment, wherein the obstacle simulates a possible actual obstacle, and wherein a current signal, resulting when the respective obstacle is struck, of the at least one electric motor of the adjustment device of the steering column is sensed and evaluated with regard to its gradient, and the limits are predefined such that the gradients of the sensed current signals lie within the limits. In particular, a gradient line that results from the determined gradients on striking a first obstacle, which is least hard compared with the other obstacles, is then advantageously defined as the lower limit, wherein the lower limit can in particular be lowered further by application of an offset thereto. A further gradient line that results from the determined gradients on striking a second obstacle, which is hardest compared with the other obstacles, then advantageously defines the upper limit, wherein the upper limit can in particular be raised further by application of an offset thereto. As a result of tests with further obstacles which, in terms of their hardness, lie between the first obstacle and the second obstacle, a check is advantageously made as to whether these lie within the lower and upper limits, wherein, if necessary, the gradient lines that form the lower limit and the upper limit are advantageously further adapted such that the gradients that result for all the further obstacles lie within the lower and upper limits.

Also advantageously, the obstacles are simulated respectively by an arrangement comprising a fixedly arranged spring element and an elastomer element facing the steering column. Different obstacles are in this case advantageously simulated by different spring constants of the spring elements and/or different Shore hardnesses of the elastomer elements. Obstacles, in particular parts of a human body, can in this way be simulated advantageously to a close approximation with little effort and at low cost. In particular, provision is made here for the spring constants to be varied with values of between 10 N/mm (N: Newton; mm: millimetre) and 75 N/mm. The Shore hardnesses are advantageously varied between a Shore A hardness of 10 and a Shore A hardness of 70.

In particular, a human finger is simulated by an arrangement made up of a spring with a spring constant of 75 N/mm and an elastomer element with a Shore A hardness of 70. More particularly, a human knee is simulated by an arrangement made up of a spring with a spring constant of 50 N/mm and an elastomer element with a Shore A hardness of 30. More particularly, a human belly is simulated by an arrangement made up of a spring with a spring constant of 10 N/mm and an elastomer element with a Shore A hardness of 10. Advantageously, the gradient line that results in the case of an arrangement made up of a spring with a greatest spring constant and an elastomer element with a greatest Shore hardness is defined as the upper limit. Advantageously, the gradient line that results in the case of an arrangement made up of a spring with a lowest spring constant and an elastomer element with a lowest Shore hardness is defined as the lower limit. The detection of actually existing pinch situations can be improved further in this way.

According to one advantageous refinement of the method for detecting a pinch situation, the evaluation of the gradient is carried out in defined adjustment ranges of the steering column. In particular, provision is made for the evaluation of the gradient to be carried out only in the adjustment ranges in which a pinch situation can occur. Advantageously, to this end, position detection of the steering column is used. Advantageously, errors in relation to the detection of a pinch situation can thus be ruled out in these ranges. Advantageously, the ranges are adaptable, in particular depending on a position of a driver's seat.

In a further advantageous refinement, the predefined limits are adaptable by parameterization, in particular are adaptable to different systems, wherein, in particular, at least one first parameter is provided to adapt the gradient for the lower limit and/or at least one second parameter is provided to adapt the upper limit. Advantageously, the method is thus better adaptable to differently configured systems, in particular differently configured steering columns.

According to a further advantageous refinement, during the evaluation of the gradient of the current signal, at least one predefinable parameter is considered. Advantageously, the at least one predefinable parameter comprises at least one of the following parameters: a debouncing time, in particular a predefined time which defines how long a gradient of the sensed current signal has to lie at least within the interval limits, and/or which defines how briefly a gradient of the sensed current signal is allowed to leave the limits; or a debouncing time and a result of a gradient counter. The gradient counter has in particular at least one of the following properties: the gradient counter is reset to zero, if the debouncing time has not been exceeded (case 1); the gradient counter maintains the current value, if the debouncing time has not been exceeded (case 2); the gradient counter is decremented, in particular to a value of zero, if the debouncing time has not been exceeded (case 3). Depending on how long the gradient of the current signal is or was back in the target range, i.e. the gradient of the current signal lies within the predefined limits, a change between the above-described behaviour of the gradient counter or the three abovementioned cases is in particular also provided. In particular, according to one refinement, the value of the gradient counter is first held for a predefined period of time (case 2), for example for 50 ms (ms: milliseconds), and is advantageously only then reset to zero (case 1). In the course of the evaluation of the gradient, it is provided in particular that, in order to detect a pinch situation, the counter has to reach a predefined value.

As a result of the at least one parameter being considered, it is advantageously possible to better prevent actual pinch results from erroneously not being detected, when these lie at least partially outside the limits. Alternatively or additionally, the method can also provide filtering of the current signal before it is evaluated in relation to the gradient, in particular likewise with the aim of leaving unconsidered possible current fluctuations which could result in departure from the predefined limits, and thus improving the detection rate.

Also advantageously, at least one further criterion is additionally checked during the adjustment of the steering column, wherein a pinch situation is detected when the at least one further criterion has additionally been met. In this refinement, a gradient of a sensed current signal than advantageously has to lie within the predefined limits and additionally the at least one criterion has to have been met in order for a pinch situation to be detected. The further criterion may in this case be in particular the falling short of an adjustment rate during an adjustment operation.

More particularly, the falling short of a speed slew rate in relation to the speed of the electric motor may be the further criterion. As a result, in particular, erroneous detections of pinch situations can be prevented even better.

In particular, it is provided that following the identification of a pinch situation, the adjustment operation of the steering column is stopped and advantageously reversed. Thus, in the case of a detected pinch situation, the steering column is advantageously adjusted counter to the adjustment direction that resulted in the pinch situation, in particular at a lower adjustment speed. Advantageously, injuries and/or damage can be prevented better in this way.

The adjustable steering column, also proposed for solving the problem mentioned at the beginning, for a motor vehicle comprises a supporting unit by which an actuator is adjustably held, and an adjustment device which is designed to adjust the actuator relative to the supporting unit, wherein the adjustment device, to adjust the actuator, comprises at least one electric motor, and wherein a control unit is assigned to the steering column. The steering column is in this case designed to carry out a method according to the invention. In particular, the control unit is in this case designed to actuate the at least one electric motor to adjust the steering column, in particular to adjust the actuator with respect to the supporting unit, wherein the control unit is also designed to sense, during an adjustment operation, for the at least one electric motor, a current signal and to evaluate a gradient of the current signal, and, during the evaluation of the gradient of the current signal, to check whether the gradient of the current signal lies within predefined limits.

The control unit is in this case in particular also designed to detect a pinch situation when the gradient of the current signal lies within the predefined limits.

In the various figures, identical parts are generally provided with the same reference signs and are therefore each only explained in conjunction with one of the figures.

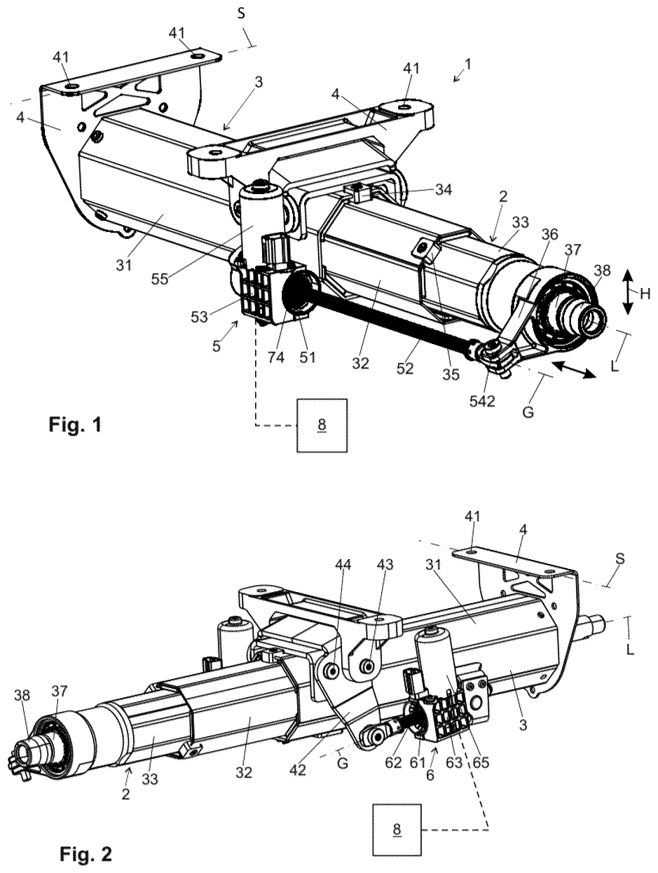

FIG. 1 shows an exemplary embodiment of an electromechanically adjustable steering column 1 according to the invention in a schematic perspective view, obliquely from the top left, towards the rear end, with respect to the direction of travel of a vehicle (not illustrated), where a steering wheel (not illustrated here) is kept in the operating range. FIG. 2 shows the steering column 1 in a view from the opposite side, i.e. as seen from the top right.

The steering column 1 comprises a jacket unit 3, which has an outer jacket tube 31, an intermediate jacket tube 32 and an inner jacket tube 33. The jacket tubes 31, 32 and 33 are arranged so as to be adjustable telescopically coaxially in one another axially, in the axial direction of a longitudinal axis L, as is indicated by the double arrow F.

Attached to the rear end of the outer jacket tube 31 is a stop 34, which protrudes inwardly, at the open end, into the intermediate space between the outer jacket tube 31 and intermediate jacket tube 32. When it is extended, the intermediate jacket tube 32 butts axially against the stop 34 and is secured against being separated from the outer jacket tube 31. Attached to the rear end of the intermediate jacket tube 32 is a stop 35 that protrudes inwardly into the intermediate space between the intermediate jacket tube 32 and inner jacket tube 33 and secures the inner jacket tube 33 against being pulled out of the intermediate jacket tube 32.

Mounted in the jacket unit 3 is a steering spindle 37 that is rotatable about the longitudinal axis L and has, at its rear end, a connection portion 38 for attaching a steering handle (not illustrated in FIG. 1 and FIG. 2). The steering spindle 37, like the jacket unit 3, is likewise designed to be telescopic in the longitudinal direction. An actuator 2 of the steering column 1 comprises the inner jacket tube 33 together with the steering spindle 37 mounted therein. To realize a longitudinal adjustment relative to the jacket unit 3, this actuator 2 is received in the outer jacket tube 31 so as to be movable telescopically in the direction of the longitudinal axis L, in order for it to be possible to position the steering wheel connected to the steering spindle 37 forward and backward in the longitudinal direction relative to the supporting unit 4, as is indicated by the double arrow F parallel to the longitudinal axis L.

The jacket unit 3 is held in a two-part supporting unit 4, which has fastening means 41 for attaching to a vehicle body (not illustrated).

The jacket unit 3 is mounted, in its front region, so as to be pivotable relative to the vehicle body about a schematically illustrated horizontal pivot axis S that is transverse to the longitudinal axis L. To this end, a pivot bearing (not illustrated) is arranged in the supporting unit 4 or between this supporting unit 4 and the vehicle body. In its rear region, the jacket unit 3 is connected to the supporting unit 2 via an adjusting lever 42. By way of a rotary movement of the adjusting lever 42 by means of an adjustment unit 6 of the adjustment device 7 of the steering column 1, as shown in FIG. 2, the jacket unit 3 can be adjusted, in particular pivoted, together with the actuator 2, relative to the supporting unit 4 about a pivot axis S that is horizontal in the installed state, with the result that, in particular, a steering handle attached to the fastening unit 38 can be adjusted in the vertical direction, as is indicated by the double arrow H.

A further adjustment unit 5 of the adjustment device 7 of the steering column 1, as shown in FIG. 1, is designed in particular for the longitudinal adjustment of the actuator 2 in the direction of the longitudinal axis L relative to the jacket unit 3 and relative to the supporting unit 4. The further adjustment unit 5 has, in this exemplary embodiment, a spindle drive with a spindle nut 51 having an internal thread 74 which extends along a spindle axis G and with which a threaded spindle 52 engages, i.e. is screwed by way of its external thread into the corresponding internal thread 74 of the spindle nut 51. The threaded-spindle axis of the threaded spindle 52 is identical to the spindle axis G in this exemplary embodiment and extends substantially parallel to the longitudinal axis L.

The spindle nut 51 is mounted rotatably about the spindle axis G in a bearing housing 53 which is fixedly connected to the outer jacket tube 31 of the jacket unit 3. In the direction of the spindle axis G, the spindle nut 51 is supported on the jacket unit 3 axially via the bearing housing 53. The adjustment device 5 is accordingly a so-called plunger spindle drive in this exemplary embodiment.

The threaded spindle 52 is connected, at its free end, to the inner jacket tube 33 so as to be supported in a rotationally and axially fixed manner on an arm 36 via a fastening bolt 542, and the spindle nut 51 is support axially, i.e. in the longitudinal direction, on the outer jacket tube 31 via the drive unit 53. The longitudinal direction corresponds to the direction of the longitudinal axis L. As a result of a relative rotation by means of the electric motor 55 of the adjustment unit 5 of the adjustment device, the threaded spindle 52 and the spindle nut 51 are moved together or apart depending on the direction of rotation, with the result that the inner jacket tube 33 is axially retracted into or extended out of the intermediate jacket tube 32, and the latter is retracted into or extended out of the outer jacket tube 31, as is indicated by the double arrow. As a result, a steering wheel that is attachable to the connection portion 38 can be moved forward into a stowed position or into an operating position. In the stowed position, the inner jacket tube 33 and the intermediate jacket tube 32 have been retracted into the outer jacket tube 31, i.e. lowered forward. In the operating position, the jacket tubes 31, 32 and 33 have been extended telescopically out of one another.

In FIG. 2, which shows a perspective view of the steering column 1 from the rear side in FIG. 1, it is apparent how the adjustment unit 6 of the adjustment device 7 for adjustment in the vertical direction has been attached to the steering column 1. The adjustment unit 6 of the adjustment device 7 is constructed in principle so as to act in the same way as the further adjustment unit 5 of the adjustment device 7. The adjustment unit 6 likewise comprises a spindle nut 61, with the internal thread of which a threaded spindle 62 engages along a spindle axis G. The threaded spindle 62 is mounted in a bearing housing 63, which is fastened to the jacket unit 3, so as to be rotatable about the axis G and supported axially, in the direction of the axis G, on the jacket unit 3, and is able to be driven in rotation selectively in both directions of rotation about the axis G by an electric motor 65.

The adjustment units 5, 6 of the adjustment device 7 of the steering column 1 are so-called plunger spindle drives in the embodiment illustrated. Alternatively, it is also possible, in particular for a rotary spindle drive to be formed, in which the spindle nut 51 is rotationally retained on the steering column 1 and the threaded spindle 52 is able to be driven in rotation by the motor 55.

The adjustment unit 6 acts on the end of the two-armed adjusting lever 42, which is mounted on the supporting unit 4 so as to be rotatable about a pivot bearing 43, and the other arm of which is connected to the jacket unit 3 at the other end in a further pivot bearing 44.

The steering column 1 also comprises a control unit 8, which is illustrated only schematically in FIG. 1 and FIG. 2. The control unit 8 is in this case designed to carry out, in a motor vehicle, during the adjustment of the steering column 1 by means of at least one electric motor 55, 65, meaning in this case adjustment of the actuator 2 relative to the supporting unit 4, a method for detecting a pinch situation. Adjustment of the steering column 1 is in this case, in particular, adjustment between a stowed position and an operating position, i.e. adjustment from a stowed position into an operating position or from an operating position into a stowed position. The control unit 8 is designed to sense, during an adjustment operation, for the at least one electric motor 55, 65, a current signal, to evaluate a gradient of the current signal, and, during the evaluation of the gradient of the current signal, to check whether the gradient of the current signal lies within predefined limits, wherein a pinch situated is detected when the gradient of the current signal lies within the predefined limits.

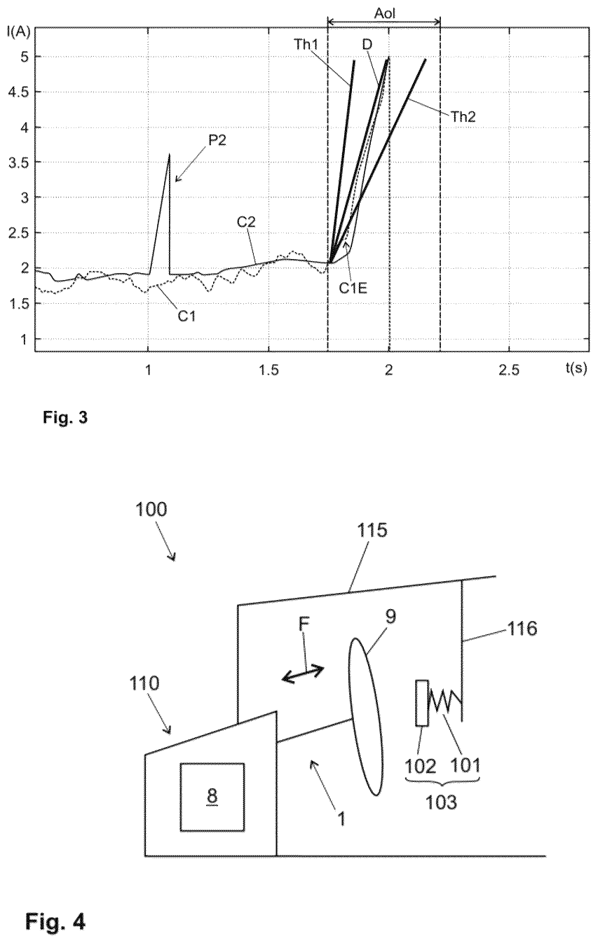

FIG. 3 shows, in the form of a graph, for example the line of a first current signal C1, resulting during a first adjustment operation of the steering column 1, of the electric motor 55 and the line of a second current signal C2, resulting during a second adjustment operation of the steering column 1, of the electric motor 55. In the diagram, the time (t) in seconds(s) is plotted on the x axis and the y axis indicates the current (I) in amps (A). In this case, for both adjustment operations, a pinch situation occurs, this resulting in the significant rise of the first current signal C1 and of the second current signal C2 in the range AoI.

The range AoI corresponds here to a previously defined adjustment range of the steering column 1, in which a pinch situation can occur at all. Within the range AoI, during an adjustment operation, for the electric motor 55, the current current signal C1, C2 is sensed and a gradient of the respective current signal C1, C2 during the respective adjustment operation is evaluated.

During the respective evaluation of the gradient of the current signal C1, C2, a check is made as to whether the gradient of the current signal C1, C2 lies within predefined limits Th1, Th2, wherein a pinch situation is detected when the gradient of the current signal C1, C2 lies within the predefined limits Th1, Th2. The limits Th1, Th2 are predefined in this exemplary embodiment by a predefined first gradient line, which forms the upper limit Th1, and a predefined second gradient line, which forms the lower limit Th2. The first gradient line is in this case a portion of a first gradient straight line, which has been determined in particular in a test series, as will be explained in more detail below with reference to FIG. 4. The second gradient line is a portion of a second gradient straight line, which has, in particular, likewise been determined in the test series. FIG. 3 shows a further gradient line D, which has, in particular, likewise been determined in the test series, and lies within the limits Th1, Th2. As is apparent from FIG. 3, the gradient of the first gradient line, i.e. the upper limit Th1, is greater than the gradient of the second gradient line, i.e. the lower limit Th2.

If, as illustrated in FIG. 3, the gradient of the sensed current signal C1, C2 now lies within the evaluation range, defined by the predefined adjustment range AoI, between the lower limit Th2 and the upper limit Th1, a pinch situation is detected. If, by contrast, a gradient of a sensed current signal remains below the lower limit Th2 or exceeds the upper limit Th1, a pinch situation is not detected. Predefined parameters define how brief falling short of and/or exceeding of one of the limits Th1, Th2 is circumvented. For example, FIG. 3 illustrates that the current signal C1 briefly falls short of the lower limit Th2 C1E. This falling short has no influence on the detection of the pinch situation.

Furthermore, FIG. 3 shows, for example, a current spike P2 of the sensed current signal C2. Since this current spike P2 occurs outside the previously defined adjustment range AoI, in which an evaluation takes place at all, the current signal C2 is not evaluated when the current spike P2 occurs, and erroneous detection of a pinch situation is avoided since this current spike P2 is attributable, in this exemplary embodiment, purely to mechanical causes during the adjustment of the steering column 1.

FIG. 4 illustrates, by way of example, a test setup 100 with which a method for setting the limits Th1, Th2, as shown in FIG. 3, can be carried out for a method for detecting a pinch situation during the adjustment of a steering column 1. The test setup comprises in this case an adjustable steering column 1 with a steering wheel 9, wherein the steering column 1 is arranged with its supporting unit fixedly in an arrangement position 110. Also arranged in the arrangement position 110 is a supporting structure 115 with a holding element 116. Arranged on the holding element 116 is a spring element 101 and an elastomer element 102 in an arrangement 103 for simulating an obstacle which the steering wheel 9 is intended to strike during the adjustment of the steering column 1. The adjustability of the steering column 1 in the longitudinal direction is symbolically illustrated in FIG. 4 by a double arrow F. The supporting structure 115 and the holding element 116 are in this case formed in a rigid manner such that their properties have a negligible effect when the steering wheel 9 strikes the arrangement 103.

In a plurality of adjustment operations of the steering column 1, the steering column 1 respectively strikes, with the steering wheel 9, during adjustment, the arrangement 103 as an obstacle, wherein a current signal, arising when the arrangement 103 is struck, of the at least one electric motor of the adjustment device of the steering column 1 is sensed and evaluated in terms of its gradient by means of a control unit 8 assigned to the steering column 1. The limits for detection of a pinch situation are in this case predefined and adapted as necessary such that the gradients of the sensed current signals lie within the limits.

By varying the elastomer element 102 with different hardnesses and varying the spring elements 101 with different spring constants, different obstacles are simulated by means of the arrangement 103. Thus a pinched human finger is simulated as an obstacle by an arrangement 103 made up of a spring element 101 having a spring constant of 75 N/mm and an elastomer element 102 with a Shore A hardness of 70. A pinched human knee is simulated as an obstacle by an arrangement 103 made up of a spring element 101 having a spring constant of 50 N/mm and an elastomer element 102 having a Shore A hardness of 30. A pinched human belly is simulated as an obstacle by an arrangement made up of a spring element 101 having a spring constant of 10 N/mm and an elastomer element 102 having a Shore A hardness of 10. Further simulations can be carried out by further combinations and further spring elements 101 and further elastomer elements 102.

A current signal that is established upon the striking of an arrangement 103 which simulates a critical pinch situation but is most resilient compared with the further arrangements 103 used is in this case evaluated with regard to its gradient. A gradient line arising from the determined gradients is defined as the lower limit Th2. A gradient line that arises in a corresponding way upon the striking of a further arrangement 103, which is hardest compared with the further arrangements 103, then defines the upper limit Th1. By way of tests with further used arrangements 103 having hardnesses that lie between the arrangements 103 defining the limits Th2, Th1, a check is then made as to whether the determined gradients of the current signals lie within the lower limit Th2 and the upper limit Th1. If necessary, the gradient lines that form the lower limit Th2 and the upper limit Th1 are readjusted such that all the gradients that are or have been determined when the steering wheel 9 strikes all of the further arrangements 103 lie within the lower limit Th2 and the upper limit Th1.

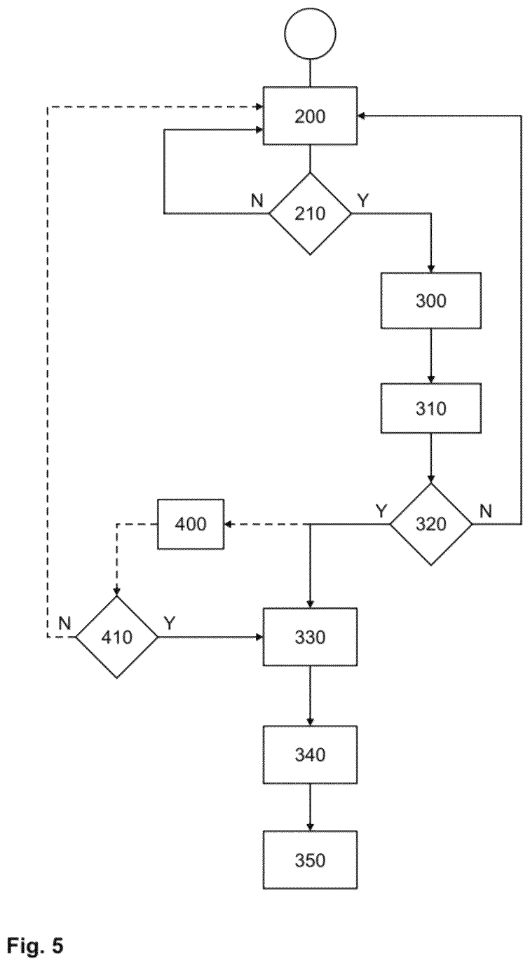

A further exemplary embodiment of a method according to the invention for detecting a pinch situation is described by way of the flow chart illustrated in FIG. 5. In this case, an electromechanical adjustment operation of the steering column starts, wherein, in a step 200, a position of the steering column or of the actuator of the steering column is sensed. In a further step 210, a check is made as to whether the position lies in a predefined adjustment range (Y) in which a pinch situation can occur, or whether it does not (N). If the detected position does not lie in the predefined adjustment range (N), initially nothing further happens; however, during the further adjustment, the position continues to be sensed (step 200) and checks are made as to whether the position lies in the predefined adjustment range.

If the position lies in the predefined adjustment range (Y), then, in a step 300, for the electric motor that is operated for the adjustment operation, a current signal is sensed. In a further step 310, a gradient of the sensed current signal is evaluated, and in a step 320, a check is made as to whether the gradient of the current signal lies within predefined limits. If this is not the case (N), the adjustment operation is continued as normal, and the steps continue to be carried out for detecting a pinch situation. If, by contrast, the gradient of the sensed current signal lies within predefined limits (Y), a pinch situation is detected in step 330.

In a further step 340, the adjustment operation is then stopped, and in a step 350, the actuator is moved counter to the original adjustment direction, in particular moved by a predefined adjustment travel counter to the original adjustment direction.

FIG. 5 also illustrates an embodiment variant which comprises the further steps 400 and 410. This can be provided optionally. This embodiment variant provides that, after the check in step 320, it has been detected that the gradient of the current signal lies within predefined limits (Y), and in step 400 a further parameter is detected. In step 410, as a further criterion during the adjustment of the steering column, a check is made as to whether the sensed parameter meets the criterion. If the parameter does not meet the criterion (N), the adjustment operation is continued, and checks continue to be made about the existence of a pinch situation. However, if the parameter meets the criterion (Y), a pinch situation is then detected in step 330, and the further steps 340, 350 then follow as described above.

The exemplary embodiments illustrated in the figures and explained in conjunction therewith serve to explain the invention and have no limiting effect thereon.

### LIST OF REFERENCE SIGNS

1 Steering column
2 Actuator
3 Jacket unit
31 Outer jacket tube
32 Intermediate jacket tube
33 Inner jacket tube
34, 35 Stop
36 Arm
37 Steering spindle
38 Connection portion
4 Supporting unit
41 Fastening means
42 Adjusting lever
43, 44 Pivot bearing
5, 6 Adjustment unit
51, 61 Spindle nut
52, 62 Threaded spindle
53, 63 Bearing housing
542 Fastening bolt
55, 65 Electric motor
7 Adjustment device
8 Control unit
9 Steering wheel
100 Test setup
101 Spring element
102 Elastomer element
103 Arrangement
110 Arrangement position
115 Supporting structure
116 Holding element
L Longitudinal axis
S Pivot axis
G Spindle axis (threaded spindle axis)
F Double arrow for symbolically illustrating longitudinal adjustability
H Double arrow for symbolically illustrating vertical adjustability
AoI Adjustment range defined for evaluation
D Gradient line
C1 Current signal
C1E Falling short of the lower limit (Th2)
C2 Current signal
P2 Current spike
Th1 Upper limit
Th2 Lower limit
200 to 410 Method steps
N Test condition not met
Y Test condition met

1. A method for detecting a pinch situation during electromechanical adjustment of a
steering column in a motor vehicle by at least one electric motor, comprising:
during an adjustment operation, for the at least one electric motor, sensing a current signal and evaluating a gradient of the current signal;
wherein, during the evaluation of the gradient of the current signal, a check is made as to whether the gradient of the current signal lies within predefined limits, wherein a pinch situation is detected when the gradient of the current signal lies within the predefined limits.

2. The method according to claim 1, wherein the limits are predefined by a first gradient line, which forms an upper limit, and a second gradient line, which forms a lower limit.

3. The method according to claim 2, wherein the first gradient line is a portion of a first gradient curve, and the second gradient line is a portion of a second gradient curve, wherein the gradient of the first gradient line is greater than the gradient of the second gradient line.

4. The method according to claim 1, wherein the limits are determined in advance, wherein, in a plurality of adjustment operations, the steering column in each case strikes an obstacle during adjustment, wherein the obstacle simulates a possible actual obstacle, and wherein a current signal, resulting when the respective obstacle is struck, of the at least one electric motor is sensed and evaluated with regard to its gradient, and the limits are predefined such that the gradients of the sensed current signals lie within the limits.

5. The method according to claim 4, wherein the obstacles are simulated respectively by an arrangement comprising a fixedly arranged spring element and an elastomer element facing the steering column, wherein different obstacles are simulated by different spring constants of the spring elements and/or different Shore hardnesses of the elastomer elements.

6. The method according to claim 5, wherein the spring constants are varied between 10 N/mm and 75 N/mm and/or the Shore hardnesses are varied between a Shore A hardness of 10 and a Shore A hardness of 70.

7. The method according to claim 1, wherein the evaluation of the gradient of the current signal is carried out in defined adjustment ranges of the steering column.

8. The method according to claim 1, wherein the predefined limits are adaptable by parameterization.

9. The method according to claim 1, wherein during the evaluation of the gradient of the current signal, at least one predefinable parameter is considered, wherein the at least one predefinable parameter comprises at least one of the following parameters: a debouncing time or a debouncing time and a result of a gradient counter.

10. The method according to claim 1, wherein at least one further criterion is additionally checked during the adjustment of the steering column, wherein a pinch situation is detected when the at least one further criterion has additionally been met.

11. The method according to claim 1, wherein following the identification of a pinch situation, the adjustment operation is stopped and reversed.

12. An adjustable steering column for a motor vehicle, comprising:
a supporting unit by which an actuator is adjustably held; and
an adjustment device which is designed to adjust the actuator relative to the supporting unit;
wherein the adjustment device, to adjust the actuator, comprises at least one electric motor and a control unit is assigned to the steering column, wherein the steering column is designed to carry out a method according to claim 1.
